(19) United States
(12) Patent Application Publication
(10) Pub. No.: US 2020/0120616 A1
(43) Pub. Date: Apr. 16, 2020

(54) RADIO FREQUENCY POWER CONTROLS

(71) Applicant: Hewlett-Packard Development Company, L.P., Spring, TX (US)

(72) Inventors: Shih Huang Wu, Houston, TX (US); Isaac Lagnado, Houston, TX (US); David Chi, Taipei City (TW)

(73) Assignee: Hewlett-Packard Development Company, L.P., Spring, TX (US)

(21) Appl. No.: 16/603,844

(22) PCT Filed: Apr. 24, 2017
(86) PCT No.: PCT/US2017/029207

§ 371 Date: Oct. 9, 2019

(51) Int. Cl. H04W 52/28; H04B 1/3827; G06F 1/16; G01B 21/22

(52) U.S. Cl. CPC H04W 52/288; G01B 21/22; G06F 1/1618; H04B 1/3838

(57) ABSTRACT

Example implementations relate to radio frequency power controls. In some examples, a computing device may comprise a processing resource and a memory resource storing machine-readable instructions to cause the processing resource to measure an angle between a first sensor and a second sensor, determine a usage mode from a plurality of usage modes based on the measured angle between the first sensor and the second sensor, and alter a radio frequency (RF) power of the radio module based on the usage mode.

### BACKGROUND

Wireless computing devices are subject to Specific Absorption Rate (SAR) limits in many countries to ensure that device users are not exposed to unacceptable irradiation levels. SAR can depend on a number of aspects including, for example, the position and orientation of the device relative to the user. For example, computing devices can operate in a number of orientations, including, laptop mode, tablet mode, and tent mode, among other orientations.

### BRIEF DESCRIPTION OF THE DRAWINGS

FIG. 1 illustrates an example of a computing device to enable radio frequency power controls consistent with the present disclosure.

FIG. 2 illustrates an example of a computing device to enable radio frequency power controls consistent with the present disclosure.

FIG. 3 illustrates an example of a system to enable radio frequency power controls consistent with the present disclosure.

FIG. 4 illustrates an example of a method for radio frequency power controls consistent with the present disclosure

### DETAILED DESCRIPTION

A computing device may include a processing resource such as electronic circuitry to execute instructions stored on machine-readable medium to perform various operations. Computing devices may be static or mobile. A static computing device may include a computing device designed for regular use in a single location. For example, a static computing device may include a desktop computer or other computing device that is utilized in a single location. A mobile computing device may include a portable computing device that is designed to be used in a variety of settings and to be transported between the two with relatively little effort. A mobile computing device may combine inputs, outputs, components, and capabilities that are otherwise separate in a static computing device. A mobile computing device may include a laptop computer, smartphone, other smart device, a tablet computer, a personal digital assistant, a convertible laptop, etc.

A user of a mobile computing device may operate a mobile computing device in a number of usage modes (laptop mode, tablet mode, tent mode, etc.). However, some usage modes correspond to a specific absorption rate (SAR) risk to the user of the notebook. For example, a mobile computing device operating in a tablet mode may result in a SAR risk to the user of the mobile computing device.

As such, controlling radio frequency (RF) power can mitigate SAR risks. For example, RF power can be reduced as a result of proximity sensors determining what usage mode the mobile computing device is operating in. However, for a metal-enclosure notebook, proximity sensors do not work because the metal enclosure can block the EM field. In other examples, display orientation using a single sensor can be used to infer which usage mode the mobile computing device is operating in (and SAR profile/risk). However, because it was determined that display orientation based on a single accelerometer did not safeguard the user from SAR exposure sufficiently, this method is no longer accepted by the FCC,

In contrast, examples of the present disclosure may include computing devices, methods, and machine-readable media to enable radio frequency power control for a mobile computing device. For example, a mobile computing device may include an integrated physical keyboard, an integrated display, and a memory resource including executable instructions to measure an angle between a first sensor and a second sensor, determine a usage mode from a plurality of usage modes based on the measured angle between the first sensor and the second sensor, and alter a radio frequency (RF) power of the radio module based on the usage mode.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

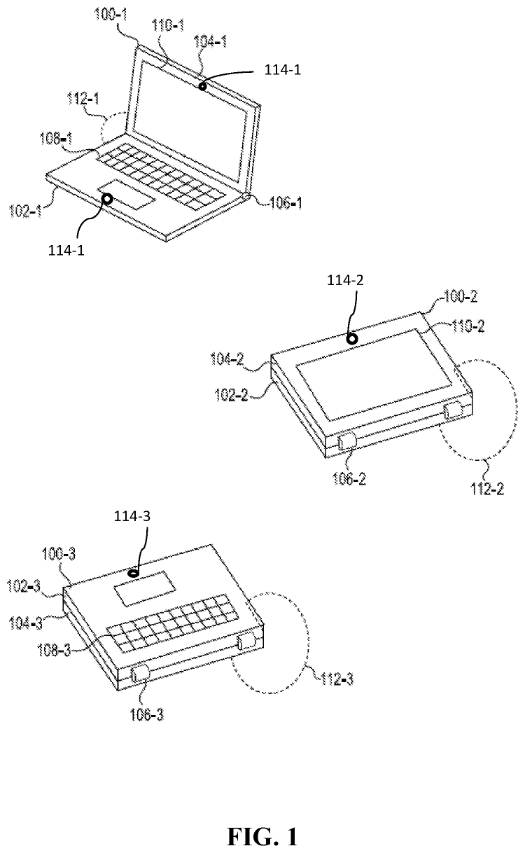

FIG. 1 illustrates an example of a computing device 100-1, 100-2, 100-3 to enable configuration based operation modes consistent with the disclosure. The computing device 100-1, 100-2, 100-3 may be a mobile computing device. The computing device 100-1, 100-2, 100-3 may be a convertible computing device. As used herein,a convertible computing device may include a computing device that is convertible for use as a traditional laptop computing device accepting input from an integrated physical keyboard and/or a touchscreen or as a tablet computing device accepting input from just the touchscreen. The convertible laptop may utilize distinct Basic Input/Output System (BIOS) modes that control the allowable or recognized inputs and/or outputs associated with the traditional laptop and tablet computing device usage modes described above.

The computing device 100-1, 100-2, 100-3 may include a plurality of connected housings (e.g., 102-1, 102-2, 102-3, 104-1, 104-2, 104-3). For example, the computing device 100-1, 100-2, 100-3 may include a first housing 102-1, 102-2, 102-3. The first housing 102-1, 102-2, 102-3 may include a housing containing the computing portion of the computing device 100-1, 100-2, 100-3. The computing portion may include the processing resource (e.g., a central processing unit (CPU), a graphics processing unit (GPU), etc.), a memory resource,an input/out port, and/or a battery. The computing portion may include the components that enable the operation of the operating system and applications of the computing device 100-1, 100-2, 100-3. The computing portion may include the hardware that executes commands and generates outputs for the computing device 100-1, 100-2, 100-3. The computing portion may include a radio module and one of the two accelerometer sensors.

The computing device 100-1, 100-2, 100-3 may include a second housing 104-1, 104-2, 104-3. The second housing 104-1, 104-2, 104-3 may include hardware associated with generating a displayed image of a user interface. The second housing 104-1, 104-2, 104-3 may also include hardware associated with a touchscreen user interface.

The first housing 102-1, 102-2, 102-3 and the second housing 104-1, 104-2, 104-3 may be connected. The connection between the first housing 102-1, 102-2, 102-3 and the second housing 104-1, 104-2, 104-3 may be designed to be a substantially permanent connection that is not designed to be readily and/or repeatedly disconnected. For example, the connection may accommodate wiring between connection points in the first housing 102-1, 102-2, 102-3 and connection points in the second housing 104-1, 104-2, 104-3 that is not releasable from the connection points in either housing without damaging the computing device 100-1, 100-2, 100-3 (e.g., wiring soldered to circuitry at the connection points).

The connection between the first housing 102-1, 102-2, 102-3 and the second housing 104-1, 104-2, 104-3 may include a hinge mechanism 106-1, 106-2, 106-3. The first housing 102-1, 102-2, 102-3 and the second housing 104-1, 104-2, 104-3 may be rotatable about the hinge mechanism 106-1, 106-2, 106-3. Rotation of the first housing 102-1, 102-2, 102-3 and the second housing 104-1, 104-2, 104-3 about a rotational axis passing through a center the hinge mechanism 106-1, 106-2, 106-3 may alter an orientation of the first housing 102-1, 102-2, 102-3 and the second housing 104-1, 104-2, 104-3 with respect to each other by altering an angle between the first housing 102-1, 102-2, 102-3 and the second housing 104-1, 104-2, 104-3.

The computing device 100-1, 100-2, 100-3 may include an integrated physical keyboard 108-1, 108-3. An integrated physical keyboard 108-1, 108-3 may include a physical keyboard, as opposed to a virtual keyboard, that is integrated with the first housing 102-1, 102-2, 102-3. For example, an integrated physical keyboard 108-1, 108-3 may include a physical keyboard that is contained on top of and/or partially within the first housing 102-1, 102-2, 102-3. The integrated physical keyboard 108-1, 108-3 may not include a releasable connection with the first housing 102-1, 102-2, 102-3 and/or the second housing 104-1, 104-2, 104-3, but rather may be inset to a face of the first housing 102-1, 102-2, 102-3. The integrated physical keyboard 108-1, 108-3 may utilize power supplied through the first housing 102-1, 102-2, 102-3 and may include a wired connection to the first housing 102-1, 102-2, 102-3. The integrated physical keyboard 108-1, 108-3 may be a physical keyboard that is a physically integrated part of the computing device 100-1, 100-2, 100-3,

The computing device 100-1, 100-2, 100-3 may include an integrated display 110-1, 110-2. An integrated display 110-1, 110-2 may include a display capable of displaying images of a graphical user interface. The integrated display 110-1, 110-2 may be integrated with the second housing 104-1, 104-2, 104-3. The hardware associated with generating a displayed image may be contained within the second housing 104-1, 104-2, 104-3. A screen portion of a display where the images are manifested may be visible on one face of the second housing 104-1, 104-2, 104-3. The integrated display 110-1, 110-2 may be overlaid with a user input detecting device such as a touchscreen. The integrated display 110-1, 110-2 may not include a releasable connection with the second housing 104-1, 104-2, 104-3 and/or the first housing 102-1, 102-2, 102-3, but rather may be inset to a face of the second housing 104-1, 104-2, 104-3. The integrated display 110-1, 110-2 may utilize power supplied through the second housing 104-1, 104-2, 104-3 and may include a wired connection to the second housing 104-1, 104-2, 104-3 and/or first housing 102-1, 102-2, 102-3. The integrated display 110-1, 110-2 may be a physically integrated part of the computing device 100-1, 100-2, 100-3.

The computing device 100-1, 100-2, 100-3 may include a memory resource. The memory resource may be utilized to stored instructions. The instructions may be executable by the processing resource to perform various operations. For example, the memory resource may include instructions executable to determine a configuration of the computing device 100-1, 100-2, 100-3.

A configuration of the computing device 100-1, 100-2, 100-3 may correspond to a particular Basic Input/Output System (BIOS) mode that the computing device 100-1, 100-2, 100-3 is operating in. The computing device 100-1, 100-2, 100-3 may function differently depending on which configuration it is in. For example, a particular configuration may be associated with particular operations, inputs, and/or outputs being allowed or not-allowed.

The determination of the configuration of the computing device 100-1, 100-2, 100-3 may be based on an orientation of the components of the computing device 100-1, 100-2, 100-3. The orientation of the components of the computing device 100-1, 100-2, 100-3 may include the positioning of the components in relation to each other and/or in relation to a user or a work surface. As used herein, a work surface may include a surface that the computing device 100-1, 100-2, 100-3 is sitting on and/or supported by during its operation. Examples of a work surface may include a desk, a user's lap, a palm of a hand, a wall, a piece of furniture, the ground, etc. Examples of an orientation may include a positional relationship between the first housing 102-1, 102-2, 102-3 and the second housing 104-1, 104-2, 104-3, a positional relationship between the integrated display 110-1, 110-2 and the integrated physical keyboard 108-1, 108-3, a positional relationship between a functional side of the integrated display 110-1, 110-2 and a functional side of the integrated physical keyboard 108-1, 108-3, and or a positional relationship of any of the above listed components and a user and/or a work surface. In some examples, the determination of the orientation of the computing device 100-1, 100-2, 100-3 can be obtained by the angle in

As used herein, a functional side of the integrated physical keyboard 108-1, 108-3 may include a surface of the integrated physical keyboard 108-1, 108-3 that accepts user touch as input. For example, the functional side of the integrated physical keyboard 108-1, 108-3 may include the surface of the integrated physical keyboard 108-1, 108-3 that is keyed with mechanically actuatable keys that correspond to particular alphanumeric and specific command inputs. As used herein, a functional side of the integrated display 110-1, 110-2 may include a surface of the integrated display 110-1, 110-2 upon and/or through which an electronic visual display can be viewed. That is, the functional side of the integrated display 110-1, 110-2 may include a displaying surface of the integrated display 110-1, 110-2. In some examples, the functional side of the integrated display 110-1, 110-2 may include a surface of the integrated display 110-1, 110-2 including a touchscreen input receiving device laid over the electronic visual display.

A positional relationship between the above mentioned components of the computing device 100-1, 100-2, 100-3 may be quantified using an angle 112-1, 112-2, 112-3 (illustrated by a hashed line) between the components. The angles 112-1, 112-2, 112-3 may be defined relative to a vertex. The vertex may include the hinge mechanism 106-1, 106-2, 106-3.

A positional relationship between the above mentioned components of the computing device 100-1, 100-2, 100-3 and a user and/or a work surface may be characterized by which way the component faces relative to the user and/or the work surface. For example, a positional relationship between a user and the functional side of the integrated display 110-1, 110-2 may be characterized by whether the functional side of the integrated display 110-1, 110-2 is facing a face of a user. In another example, a positional relationship between a work surface and an integrated physical keyboard 108-1, 108-3 may be characterized by whether the functional side of the integrated physical keyboard 108-1, 108-3 is facing the work surface,

The orientation of the components of the computing device 100-1, 100-2, 100-3 may be determined based on sensors 114-1, 114-2, 114-3 in the computing device 100-1, 100-2, 100-3. For examples, the orientation of the components of the computing device 100-1, 100-2, 100-3 may utilize sensors 114-1, 114-2, 114-3 such as cameras, light sensors, pressure sensor, accelerometers, etc. In other examples, the orientation of the components of the computing device 100-1, 100-2, 100-3 may be determined utilizing sensors 114-1, 114-2, 114-3, such as accelerometers. A first sensor 100-1, 100-2, 100-3 can be installed within the first housing 102-1, 102-2, 102-3 of the computing device 100-1, 100-2, 100-3 and a second sensor can be installed within the second housing 104-1, 104-2, 104-3 of the computing device 100-1, 100-2, 100-3. The orientation of the components of the computing device 100-1, 100-2, 100-3 may also be determined based on user input specifying an orientation. Additionally, the orientation of the components of the computing device 100-1, 100-2, 100-3 may also be determined based on an angle between a sensor and gravity.

As described herein, a usage mode can be determined from a plurality of modes based on the measured angle between a first sensor 114-1, 114-2, 114-3 and a second sensor 114-1, 114-2, 114-3. In some examples, the usage mode can be determined from a plurality of modes based on the angle between a first sensor 114-1, 114-2, 114-3 and gravity. For example, the plurality of modes includes a laptop mode, a tablet mode, a tent mode, a flat mode, and a stand mode, among other usage modes.

For example, based on the measured angle between the first accelerometer sensor and the second accelerometer an EC can determine which usage mode the computing device 100-1, 100-2, 100-3 is operating in. As described herein, each usage mode can correspond to a predefined open angle range. For example, the laptop mode can correspond to a display open angle of less than 155 degrees, the tablet mode can correspond to a display open angle of greater than 345 degrees, the tent mode can correspond to a display open angle of between 210 degrees and 335 degrees, the flat mode can correspond to greater between 165 degrees and 200 degrees, and the stand mode can correspond to between 210 degrees and 335 degrees. In some examples, the angle between the first sensor 114-1, 114-2, 114-3 and/or the second sensor 114-1, 114-2, 114-3 and gravity may be used to differentiate different usage modes with the same open angle range.

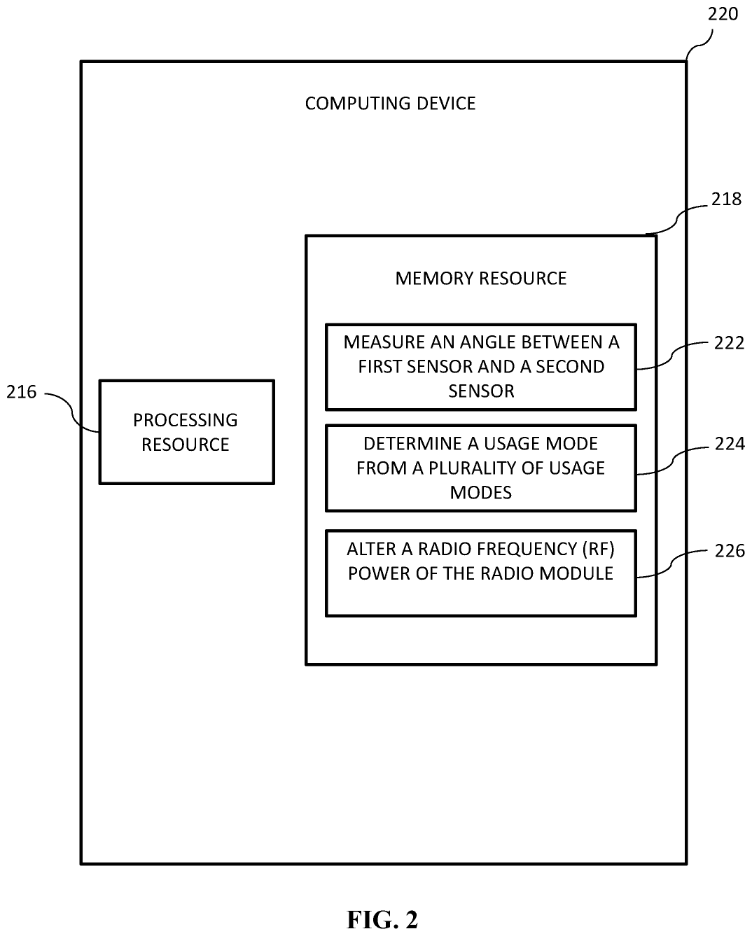

FIG. 2 illustrates an example of a computing device 220 to enable radio frequency power controls consistent with the present disclosure. The computing device 220 may be a convertible computing device. As used herein, a convertible computing device may include a computing device 220 that is convertible for use as a traditional laptop computing device accepting input from an integrated physical keyboard and/or a touchscreen or as a tablet computing device accepting input from just the touchscreen. The convertible laptop may utilize distinct Basic Input/Output System (BIOS) modes that control the allowable or recognized inputs and/or outputs associated with the traditional laptop and tablet computing device usage modes described above.

As illustrated in FIG. 2, the computing device 220 can include a processing resource 216. The computing device 220 may further include a memory resource 218 coupled to the processing resource 216, on which instructions may be stored, such as instructions 222, 224, and 226. Although the following descriptions refer to a single processing resource and a single memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

Processing resource 216 may be a central processing unit (CPU), a semiconductor based microprocessor, and/or other hardware devices suitable for retrieval and execution of instructions stored in memory resource 218. Processing resource 216 may fetch, decode, and execute instructions 222, 224, and 226, or a combination thereof. As an alternative or in addition to retrieving and executing instructions, processing resource 216 may include at least one electronic circuit that includes electronic components for performing the functionality of instructions 222, 224, and 226, or a combination thereof.

Memory resource 218 can be volatile or nonvolatile memory. Memory resource 218 can also be removable (e.g., portable) memory, or non-removable (e.g., internal) memory. For example, memory resource 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM), flash memory, a laser disc, a digital versatile disk (DVD) or other optical disk storage, and/or a magnetic medium such as magnetic cassettes, tapes, or disks, among other types of memory.

Instructions 222, when executed by processing resource 216, may cause the processing resource 216 to measure an angle between a first sensor and a second sensor. In some examples, the first sensor can be installed in a first housing of the computing device 220 and the second sensor can be installed in a second housing of the computing device 220. As described herein, the first and second sensors can be accelerometer sensors.

As described herein, a first housing of the computing device 220 may include an integrated physical keyboard. For example, an integrated physical keyboard may include a physical keyboard that is contained on top and/or partially within the first housing of the computing device 220. As described herein, the second housing of the computing device 220 may include an integrated display.

Instructions 222, may include instructions to determine an orientation of a computing device 220. As described herein, the computing device 220 can be a convertible computing device. The convertible computing device may include a computing device 220 that is convertible for use as a traditional laptop computing device accepting input from an integrated physical keyboard and/or a touchscreen or as a tablet computing device accepting input from just the touchscreen,

As described herein, determination of the orientation of the computing device 220 may be based on an orientation of the first housing of the computing device 220 and the second housing of the computing device 220. The orientation of the first housing of the computing device 220 and the second housing of the computing device 220 may include the positioning of the first housing and the second housing of the computing device 220 in relation to each other and/or in relation to a user or a work surface. As used herein, a work surface may include a surface that the computing device 220 is sitting on and/or supported by during its operation. Examples of work surface may include a desk, a user's lap, a palm of a hand, a wall, a piece of furniture, the ground, etc. An example of an orientation may include a positional relationship between the first housing of the computing device and the second housing of the computing device.

A positional relationship between the first housing of the computing 220 device and the second housing of the computing device 220 may be quantified using an angle between the first housing of the computing device 220 and the second housing of the computing device 220. A positional relationship between the first housing of the computing device 220 and the second housing of the computing device 220 and a user and/or work surface may be characterized by which way the component faces relative to the user and/or the work surface.

In some examples, the orientation of the components of the computing device 220 may be determined based on sensors in the computing device 220. For example, the orientation of the components of the computing device 220 may be determined utilizing sensors such as accelerometers. That is, an open angle range of the computing device 220 may be determined utilizing sensors. For example, the display open angle can be obtained by measuring the difference between the first sensor and the second sensor. In some examples, the open angle range may be used in conjunction with data obtained by the first and/or second sensor to provide a reference to earth to determine the orientation of the computing device. For instance, sensors can be used to determine if the computing device is being held in conjunction with the angle between the first and second housing.

Instructions 224, when executed by processing resource 216, may cause the processing resource 216 to determine a usage mode from a plurality of modes based on the measured angle between the first sensor and the second sensor. For example, the plurality of modes includes a laptop mode, a tablet mode, a tent mode, a flat mode, and a stand mode, among other usage modes.

As described herein, an Embedded Controller (EC) can determine the usage mode from the plurality of usage modes. The EC hardware may use data collected by the first and second sensor to identify when the computing device 220 is in a usage mode. As a result, the EC can take action and/or generate events to the BIOS which are passed on to software to each mode related to screen orientation, selection of thermal profile, or other appropriate action. For example, based on the measured angle between the first accelerometer sensor and the second accelerometer an EC can determine which usage mode the computing device 220 is operating in.

As described herein, each usage mode can correspond to a predefined open angle range. For example, the laptop mode can correspond to a display open angle of less than 155 degrees, the tablet mode can correspond to a display open angle of greater than 345 degrees, the tent mode can correspond to a display open angle of between 210 degrees and 335 degrees, the flat mode can correspond to greater between 165 degrees and 200 degrees, and the stand mode can correspond to between 210 degrees and 335 degrees.

As described herein, the EC can determine whether there is a SAR risk that corresponds to the determined usage mode. For example, in an instance where the EC determines that the computing device 220 is operating in a usage mode that corresponds to a SAR risk the EC may generate events to a radio module to control the RF power. For example, the RF power can be reduced to a level that causes an acceptably low SAR for the user.

As described herein, the computing device 220 may identify a RF power of a radio module. For example, identifying the RF power of the radio module can correspond to the usage mode. As described herein, the usage mode can correspond to a particular level of SAR risk. For example, when the usage mode corresponds to a particular level of SAR risk, the computing device 220 can identify a reduced RF power of the radio module to be utilized. Thus, identifying a RF power can mitigate the SAR risk to a user of the computing device 220 by altering the RF power of the computing device 220. In another example, when the usage mode corresponds to no SAR risk, the computing device 220 can identify a normal RF power of the radio model.

For example, a computing device 220 operating in laptop mode or standing mode may correspond to a relatively lower level of SAR risk. However, a computing device 220 operating in flat mode, tent mode, or tablet mode may correspond to a relatively higher level of SAR risk. Thus, because a computing device 220 operating in flat mode, tent mode, or tablet mode may correspond to a relatively higher SAR risk, the RF power can be reduced to reduce or mitigate the SAR risk.

As described herein, in an instance where the computing device 220 determines that the RF power of the radio module may be altered, the computing device 220 can determine that the radio module go into Dynamic Power Reduction (DPR) mode. As described herein, RF power may relate to the SAR level, and SAR levels may be dependent upon frequency. Therefore, the RF power may need to be reduced based on the frequency as a result of a SAR exposure situation being identified (i.e., computing device is operating in tent mode, etc.). For example, a radio module in DPR mode can use a DPR table to determine how much the RF power is reduced to mitigate the SAR risk to the user of the computing device 220. A DPR table can indicate how much the RF power can be reduced based on the frequency to mitigate the SAR risk.

As described herein, the DPR table can indicate the RF power of the radio module that causes an acceptably low SAR (e.g., SAR level identified by an agency to be an acceptable SAR level, etc.) for the user. For example, the RF power of the radio module can be altered to the RF power that the DPR table identifies as causing an acceptable low SAR for the user. In some examples, the determined usage mode can be utilized for additional functions relating to the computing device 220 including a keyboard, a camera, and screen rotation.

Instructions 226, when executed by processing resource 216, may cause the processing resource 216 to alter a RF power of the radio module based on the usage mode. For example, the RF power of the radio module can be altered to the identified RF power. As described herein, in the case that the SAR risk indicates that the computing device 220 be placed into DPR mode, the computing device 220 can alter the RF power of the radio module to the identified power. The identified power can be determined based on the RF power that corresponds to the SAR risk/usage mode.

As described herein, the computing device 220 can alter the RF power of the radio module via Hardware General Purpose Input Output (HW GPIO) signals or Software Application Programming Interface (SW API) calls. For example, in an instance that the EC detects that the computing device 220 is operating in a usage mode that corresponds to a particular level of SAR risk, the computing device 220 can alter the RF power of the radio module. For example, the computing device 220 can alter the RF power of the radio to a power identified by the DPR table as resulting in an acceptably low SAR.

As described herein, the computing device 220 can alter the RF power of the radio module to the identified RF power via HW GPIO signals or SW API calls. For example, the computing device 220 can reduce the RF power of the radio module to mitigate the SAR in the computing device 220. For example, when the computing device 220 utilizes HW GPIO signals, the EC can be connected by a signal directly to the radio module. Thus, when the EC raises a voltage level on a signal, the radio module can sense the voltage level and trigger an action, such as going into DPR mode.

In some example, when the computing device 220 utilizes SW API calls, the EC can have communication with operating systems. Thus, when the EC determines that the computing device 220 is operating in a usage mode that corresponds to a particular level of SAR risk the EC can create an operating system (OS) event, wherein a SW service can register for and monitor for these type of events (i.e., computing device 220 is operating in a mode corresponding to a particular level of SAR risk, etc.) in the OS. A SW can notify the radio module to go into a DPR mode when it detects such an event. As a result, the radio module HW may receive the notification and can notify its circuitry to go into a DPR mode.

As described herein, the computing device 220 can alter a RF power of the radio module into a reduced power state. For example, once the RF power is reduced the SAR levels can be reduced to a level that is an acceptably low SAR.

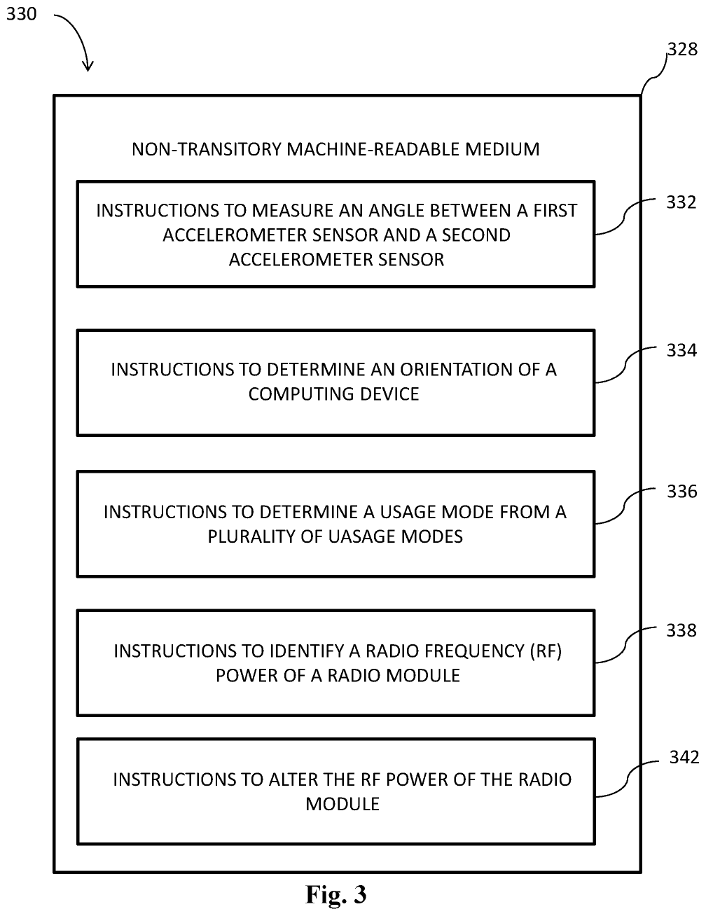

FIG. 3 illustrates an example of system 330 to enable radio frequency power controls consistent with the present disclosure. System 330 may include a non-transitory machine readable storage medium 328. Non-transitory machine readable storage medium 328 may be an electronic, magnetic, optical, or other physical storage device that stores executable instructions. Thus, non-transitory machine readable storage medium 328 may be, for example, Random Access Memory (RAM), an Electrically-Erasable Programmable Read-Only Memory (EEPROM), a storage drive, an optical disc, and the like. Non-transitory machine readable storage medium 328 may be disposed within system 330, as shown in FIG. 3. In this example, the executable instructions may be “installed” on the system 320. Additionally and/or alternatively, non-transitory machine readable storage medium 328 may be a portable, external or remote storage medium, for example, that allows system 330 to download the instructions from the portable/external/remote storage medium. In this situation, the executable instructions may be part of an “installation package”. As described herein, non-transitory machine readable storage medium 328 may be encoded with executable instructions for a performance threshold.

Instructions 332 may include instructions to measure an angle between a first accelerometer sensor and a second accelerometer sensor. In some examples, the first accelerometer sensor can be installed in a first housing of the computing device and the second accelerometer sensor can be installed in a second housing of the computing device. As described herein, a first housing of the computing device may include an integrated physical keyboard. For example, an integrated physical keyboard may include a physical keyboard that is contained on top and/or partially within the first housing of the computing device. As described herein, the second housing of the computing device may include an integrated display.

Instructions 334 may include instructions to determine an orientation of a computing device. As described herein, the computing device can be a convertible computing device. The convertible computing device may include a computing device that is convertible for use as a traditional laptop computing device accepting input from an integrated physical keyboard and/or a touchscreen or as a tablet computing device accepting input from just the touchscreen.

As described herein, determination of the orientation of the computing device may be based on an orientation of the first housing and the second housing of the computing device. The orientation of the first housing and the second housing of the computing device of the computing device may include the positioning of the display and the first housing of the computing device in relation to each other and/or in relation to a user or a work surface.

The positional relationship between the first housing and the second housing of the computing device may be quantified using an angle between the first housing and the second housing of the computing device. A positional relationship between the first housing and the second housing of the computing device and a user and/or work surface may be characterized by which way the component faces relative to the user and/or the work surface. The orientation of the first housing and the second housing of the computing device may be determined utilizing the first accelerometer sensor and the second accelerometer sensor. That is, the open angle range of the computing device may be determined utilizing accelerometer sensors.

Instructions 336 may include instructions to determine a usage mode from a plurality of usage modes. As described herein, the plurality of usage modes include laptop mode, tablet mode, and tent mode, among other orientations. Each of the plurality of usage modes corresponds to a predefined open angle range. For example, based on the measured angle between the first accelerometer sensor and the second accelerometer, an EC can determine which usage mode the computing device is in.

Instructions 338 may include instructions to identify a RF power of a radio module. For example, identifying the RF power of the radio module can correspond to the usage mode. As described herein, the usage mode can correspond to a particular level of SAR risk. For example, when the usage mode corresponds to a particular level of SAR risk, the computing device can identify a reduced RF power of the radio module. Thus, identifying a RF power can mitigate the SAR risk to a user of the computing device by altering the RF power of the computing device. In another example, when the usage mode corresponds to an acceptably low SAR, the computing device may not have to reduce the RF power of the radio model.

As described herein, in an instance where the computing device determines that the RF power of the radio module may be altered, the computing device can determine that the radio module go into DPR mode. For example, a radio module in DPR mode can use a DPR table to determine how much the RF power is reduced to mitigate the SAR risk to the user of the computing device.

Instructions 342 may include instructions to alter the RF power of the radio module. For example, the RF power of the computer module can be altered to the identified RF power. As described herein, in the case that the SAR risk indicates that the computing device be placed into DPR mode, the computing device can alter the RF power of the radio module to the identified power. The identified power can be determined based on the RF power that corresponds to the SAR risk/usage mode.

As described herein, the computing device can alter the RF power of the radio module via HW GPIO signals or SW API calls. For example, in an instance that the EC detects that the computing device is operating in a usage mode that corresponds to a SAR risk, the computing device can alter the RF power of the radio module to the identified RF power via HW GPIO signals or SW API calls. As described herein, the computing device can reduce the RF power of the radio module to mitigate the SAR risk in the computing device.

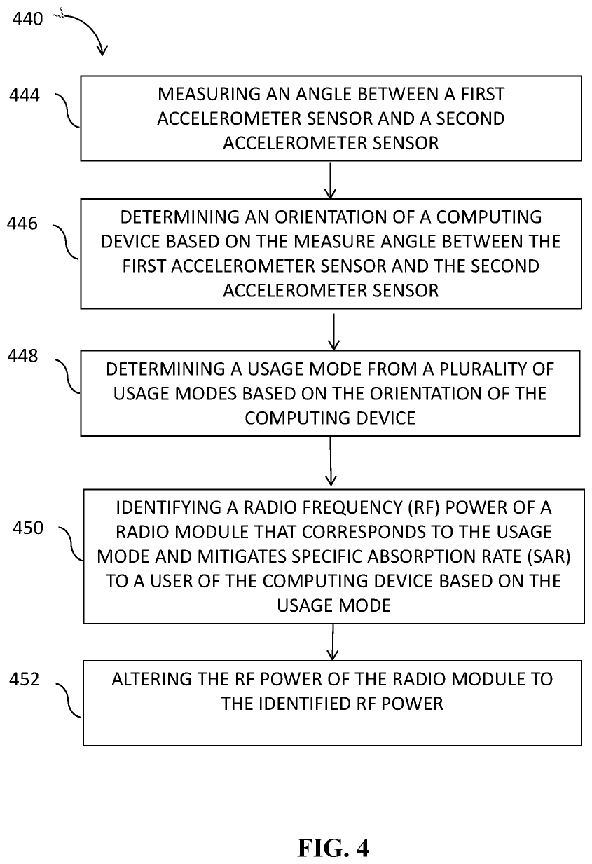

FIG. 4 illustrates an example of a method 440 for radio frequency power controls consistent with the present disclosure. In some examples, the method 440 can be performed by a computing device, as described herein. For example, the method 440 can be performed by computing device 100 as illustrated in FIG. 1.

As described herein, at 444, the method 440 can include measuring an angle between a first accelerometer sensor and a second accelerometer sensor. In some examples, the first accelerometer sensor can be installed in a first housing of the computing device and the second accelerometer sensor can be installed in a second housing of the computing device.

As described herein, at 446, the method 440 can include determining the orientation of a computing device based on the measured angle between the first accelerometer sensor and the second accelerometer sensor. As described herein, the positional relationship between the first housing and the second housing of the computing device may be quantified using an angle between the first housing and the second housing of the computing device. A positional relationship between the first housing and the second housing of the computing device and a user and/or work surface may be characterized by which way the component faces relative to the user and/or the work surface. The orientation of the first housing and the second housing of the computing device may be determined utilizing the first accelerometer sensor and the second accelerometer sensor. That is, the open angle range of the computing device may be determined utilizing accelerometer sensors.

As described herein, at 448, the method 440 can include determining a usage mode from a plurality of usage modes based on the orientation of the computing device. As described herein, the plurality of usage modes include laptop mode, tablet mode, and tent mode, among other orientations. Each of the plurality of usage modes corresponds to a predefined open angle range. For example, based on the measured angle between the first accelerometer sensor and the second accelerometer an EC can determine which usage mode the computing device in.

As described herein, at 450, the method 440 can include identifying a RE power of a radio module that corresponds to the usage mode and mitigates SAR to a user of the computing device based on the usage mode. For example, the usage mode may correspond to a SAR risk. As described herein, the SAR risk can indicate that the radio module be placed into DPR mode.

As described herein, at 452, the method 440 can include altering the RF power of the radio module to the identified RF power. For example, in the case that the SAR risk indicates that the computing device be placed into a DPR, the computing device can alter the RF power of the radio module to the identified power. The identified power can be determined based on the RF power that corresponds to the SAR risk/usage mode.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A computing device, comprising:
a processing resource; and
a memory resource storing machine-readable instructions to cause the processing resource to:
measure an angle between a first sensor and a second sensor;
determine a usage mode from a plurality of usage modes based on the measured angle between the first sensor and the second sensor; and
alter a radio frequency (RF) power of the radio module based on the usage mode.

2. The computing device of claim 1, wherein the first and second sensors are accelerometer sensors.

3. The computing device of claim 1, wherein the first sensor is installed in a first housing of the computing device and the second sensor is installed in a second housing of the computing device.

4. The computing device of claim 1, wherein the plurality of usage modes includes a laptop mode, a tablet mode, and a tent mode.

5. The computing device of claim 4, wherein each usage mode corresponds to a predefined open angle range.

6. The computing device of claim 5, wherein the laptop mode corresponds to a display open angle of less than 155 degrees, the tablet mode corresponds to a display open angle of greater than 345 degrees, and the test mode corresponds to a display open angle of between 165 degrees and 200 degrees,

7. The computing device of claim 1, wherein an Embedded Controller (EC) determines the usage mode from the plurality of usage modes.

7. The computing device of claim 5, wherein the laptop mode corresponds to a display open angle of less than 155 degrees, the tablet mode corresponds to a display open angle of greater than 345 degrees, and the test mode corresponds to a display open angle of between 165 degrees and 200 degrees.

8. A non-transitory machine-readable storage medium having stored thereon machine-readable instructions to cause a computing processor to:
measure an angle between a first accelerometer sensor and a second accelerometer sensor;
determine an orientation of a computing device based on the measured angle between the first accelerometer sensor and the second accelerometer sensor;
determine a usage mode from a plurality of usage modes based on the orientation of the computing device;
identify a radio frequency (RF) power of a radio module that corresponds to the usage mode; and
alter the RF power of the radio module to the identified RF power.

9. The computing device of claim 8, comprising instructions to alter the RF power of the radio model via HW GPIO signals.

10. The computing device of claim 8, comprising instructions to alter the RF power of the radio model via SW API calls.

11. The computing device of claim 8, comprising instructions to utilize the determined usage mode for additional functions relating to the computing device including a keyboard, a camera, and screen rotation.

12. The computing device of claim 8, comprising instructions to alter the RF power of the radio module to mitigate a specific absorption rate (SAR) in the computing device.

13. A method comprising:
measuring an angle between a first accelerometer sensor and a second accelerometer sensor;
determining an orientation of a computing device based on the measured angle between the first accelerometer sensor and the second accelerometer sensor;
determining a usage mode from a plurality of usage modes based on the orientation of the computing device;
identifying a radio frequency (RF) power of a radio module that corresponds to the usage mode and mitigates SAR to a user of the computing device based on the usage mode; and
altering the RF power of the radio module to the identified RF power.

14. The method of claim 13, wherein the usage mode corresponds to a specific absorption rate (SAR) risk.

15. The method of claim 14, wherein an SAR risk indicates that the radio module be placed into a dynamic power reduction (DPR) mode
